(19) United States
(12) Patent Application Publication
(10) Pub. No.: US 2015/0256708 A1
(43) Pub. Date: Sep. 10, 2015

(54) PHOTO MEDIA DISPLAYING METHOD, PHOTO MEDIA PRINTING METHOD, AND PHOTO MEDIA DISPLAYING AND PRINTING SYSTEM

(71) Applicant: Primax Electronics Ltd., Taipei (TW)

(72) Inventor: JUNG-CHANG YANG, Taipei (TW)

(21) Appl. No.: 14/297,356

(22) Filed: Jun. 5, 2014

(30) Foreign Application Priority Data
Mar. 7, 2014 (TW) 103107994

(51) Int. Cl. H04N 1/32; G06T 1/00; H04N 1/00

(52) U.S. Cl. CPC H04N 1/32325; H04N 1/00482; H04N 1/32315; H04N 1/00167; H04N 1/00188; G06T 1/005; H04N 1/00161

(57) ABSTRACT

A photo media displaying method and a photo media printing method are provided. Firstly, a photo media file is selected by an active control device of an area network. Then, a marked is added to the selected photo media file by a digital media server, so that a new photo media file containing the mark is produced. Then, the new photo media file is transmitted from the digital media server to a digital media renderer of the area network, so that the new photo media file is displayed on the digital media renderer. Moreover, the new photo media file may be transmitted to a network printing device of the area network, so that the new photo media file is printed out by the network printing device. In other words, the mark is added to the photo media file by simply selecting the photo media file.

### FIELD OF THE INVENTION

The present invention relates to a photo media displaying method and a photo media printing method, and more particularly to a photo media displaying method and a photo media printing method for displaying and printing photo media files in an area network.

### BACKGROUND OF THE INVENTION

Generally, an area network comprises a local area network (LAN), a metropolitan area network (MAN) and a wide area network (WAN). With increasing development of science and technology, the area network further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone to be connected to a computer host in a study room. Moreover, through the smart phone, the user may browse the audio files in the computer host and select a desired audio file from the computer host. Then, the selected audio file is transmitted from the smart phone to a stereo device in the living room. After the audio file is received by the stereo set, the audio file is played by the stereo device. Consequently, the purposes of conveniently and quickly sharing media contents can be achieved by the DLNA system.

In addition to the digital media server, the digital media controller, the digital media renderer and the digital media player, a digital media printer (DMPr) complying with the DLNA protocol is also introduced to the market. The digital media printer may acquire a photo media file from the DLNA system. After the photo media file from the DLNA system is acquired, the photo media file may be printed out by the digital media printer. With the advance of the digital media printer, it is easier to print out the photo media file that is shared in the DLNA system. However, some problems may occur. For example, the photo media file may be embezzled by other users. For preventing the photo media file from being embezzled, a mark including a specified information (e.g. the name of the sharer of the photo media file or a website address of a personal social networking website) is usually added to the shared photo media file. For example, the mark is a watermark or a stamp mark.

However, the process of adding the mark to the photo media file is troublesome to the user. A conventional process of adding the mark to the photo media file will be illustrated as follows. Firstly, the user may operate a third-party device (e.g. a computer, a smart phone or a tablet computer) to execute a specified application program to add the mark to the photo media file. Then, the photo media file with the mark is transmitted to the DLNA system. Consequently, the photo media file may be shared through the DLNA system. According to the mark contained in the photo media file, other users may recognize the source of the photo media file, so that the photo media file will not be embezzled. Moreover, after the photo media file with the mark is transmitted to the DLNA system, the photo media file with the mark may be further printed out by a digital media printer of the DLNA system. For most users, the above operating method is inconvenient and troublesome.

Therefore, there is a need of providing a photo media displaying method, a photo media printing method and a photo media displaying and printing system using a simplified anti-embezzling process.

### SUMMARY OF THE INVENTION

An object of the present invention provides a photo media displaying method and a photo media printing method using a simplified anti-embezzling process.

Another object of the present invention provides a photo media displaying and printing system using a simplified anti-embezzling process.

In accordance with an aspect of the present invention, there is provided a photo media printing method. Firstly, a first electronic device of an area network receives a print command corresponding to a photo media file, so that a print request corresponding to the photo media file is transmitted from the first electronic device to a network printing device of the area network. The photo media file is stored in a second electronic device of the area network. Then, the second electronic device adds a mark to the photo media file according to a retrieve request corresponding to the photo media file from the network printing device, so that a new photo media file containing the mark is produced. Then, the new photo media file is transmitted from the second electronic device to the network printing device, so that the new photo media file is printed out by the network printing device.

In accordance with another aspect of the present invention, there is provided a photo media displaying method. Firstly, a first electronic device of an area network receives a retrieve command corresponding to a photo media file, so that a photo thumbnail corresponding to the photo media file is retrieved from a second electronic device of the area network. The photo media file and the photo thumbnail are stored in the second electronic device. Then, the photo thumbnail is outputted from the second electronic device, so that the photo thumbnail is displayed on the first electronic device. Then, the second electronic device receives a select command corresponding to the photo media file from the first electronic device, so that the mark is added to the selected photo media file according to the select command and a new photo media file containing the mark is produced. Then, the new photo media file is transmitted from the second electronic device to the first electronic device or a third electronic device of the area network, so that the new photo media file is displayed on the first electronic device or the third electronic device.

In accordance with a further aspect of the present invention, there is provided a photo media displaying and printing system. The photo media displaying and printing system includes a network router, an active control device, a digital media printer, and a digital media server. The network router provides a network connection function. The active control device is connected to the network router through network connection. The active control device includes a first display screen and an operation interface. A photo media file and a new photo media file containing a mark are displayed on the first display screen. The operation interface receives a select command corresponding to the photo media file and a print command corresponding to the photo media file. The active control device issues a print request according to the print command. The digital media printer is connected to the network router through network connection and connected to the active control device via the network router through network connection. The digital media printer issues a retrieve request corresponding to the photo media file. After the new photo media file is received, the new photo media file is printed out by the digital media printer. The digital media server is connected to the network router through network connection, and connected to the active control device and the digital media printer via the network router through network connection. The digital media server includes a storage element and a controlling element. The mark and the photo media file are stored in the storage element. The controlling unit is connected to the storage element. The controlling unit adds the mark to the selected photo media file according to the retrieve request so as to produce and output the new photo media file, or the controlling unit adds the mark to the selected photo media file according to the print request so as to produce and output the new photo media file to the digital media printer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

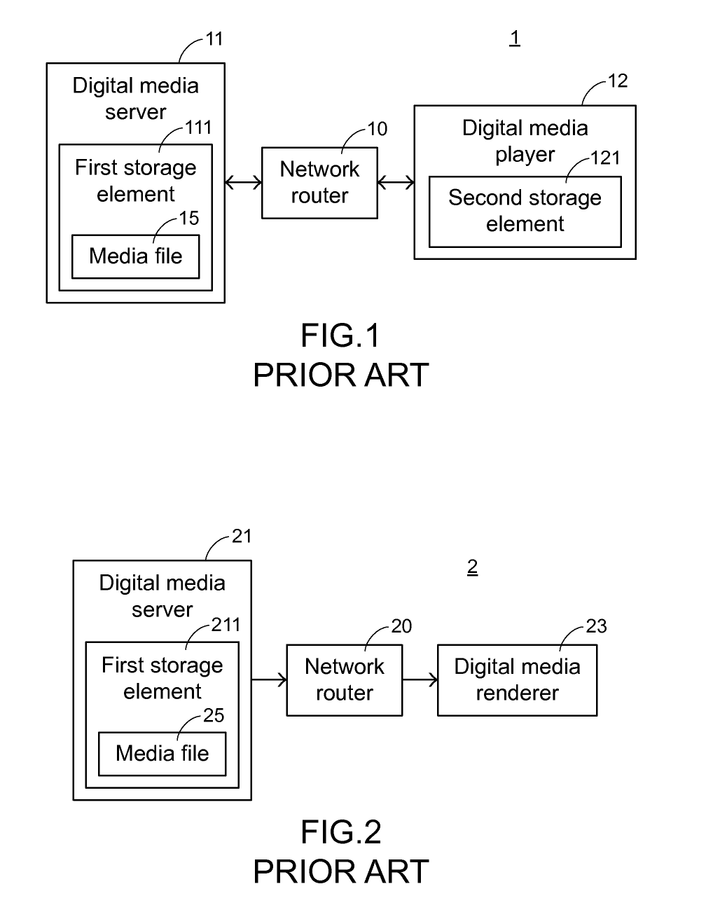

FIG. 2 schematically illustrates the architecture of a second conventional DLNA system;

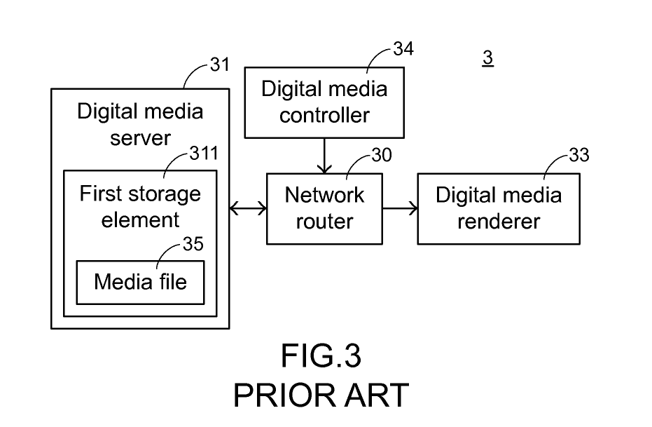

FIG. 3 schematically illustrates the architecture of a third conventional DLNA system;

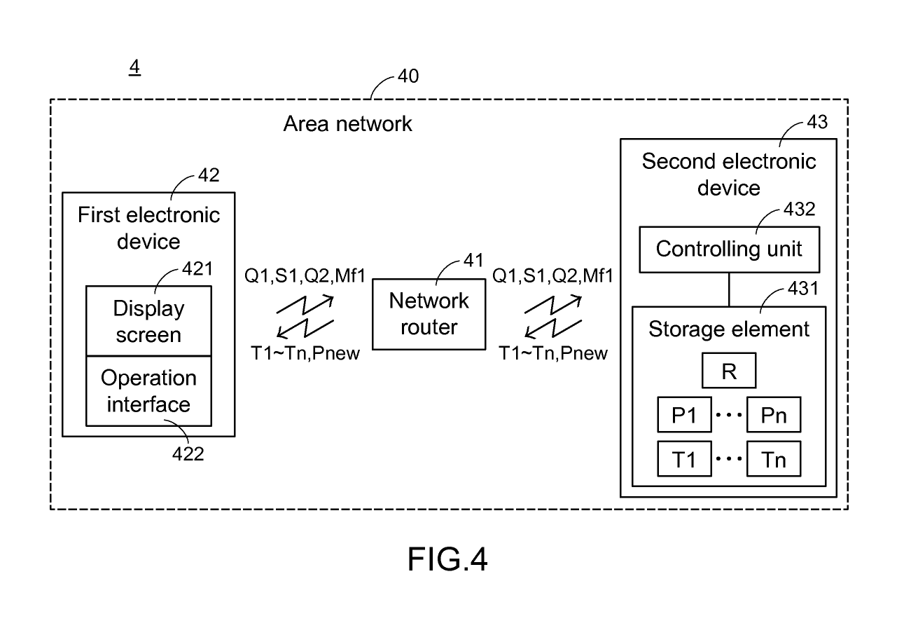

FIG. 4 is a schematic functional block diagram illustrating a photo media displaying system according to a first embodiment of the present invention;

FIG. 5 is a flowchart illustrating a photo media displaying method according to a first embodiment of the present invention

FIG. 6 schematically illustrates plural thumbnails corresponding to plural photo media files of the photo media displaying system according to the first embodiment of the present invention;

FIG. 7 schematically illustrates a new photo media file produced by the photo media displaying system according to the first embodiment of the present invention;

FIG. 8 is a schematic functional block diagram illustrating a photo media displaying system according to a second embodiment of the present invention;

FIG. 9A and FIG. 9B are flowcharts illustrating a photo media displaying method according to a second embodiment of the present invention. The photo media displaying method comprises the following steps;

FIG. 10 schematically illustrates plural default marks of the photo media displaying system according to the second embodiment of the present invention; and

FIG. 11 is a schematic functional block diagram illustrating a photo media displaying and printing system according to a third embodiment of the present invention;

FIG. 12A and FIG. 12B are flowcharts illustrating a photo media displaying and printing method according to a third embodiment of the present invention.

### DETAILED DESCRIPTION OF THE PREFERRED EMBODIMENT

For obviating the drawbacks of the prior art technologies, the present invention provides a photo media displaying method and a photo media printing method for displaying and printing photo media files in an area network and a photo media displaying and printing system for implementing the methods of the present invention.

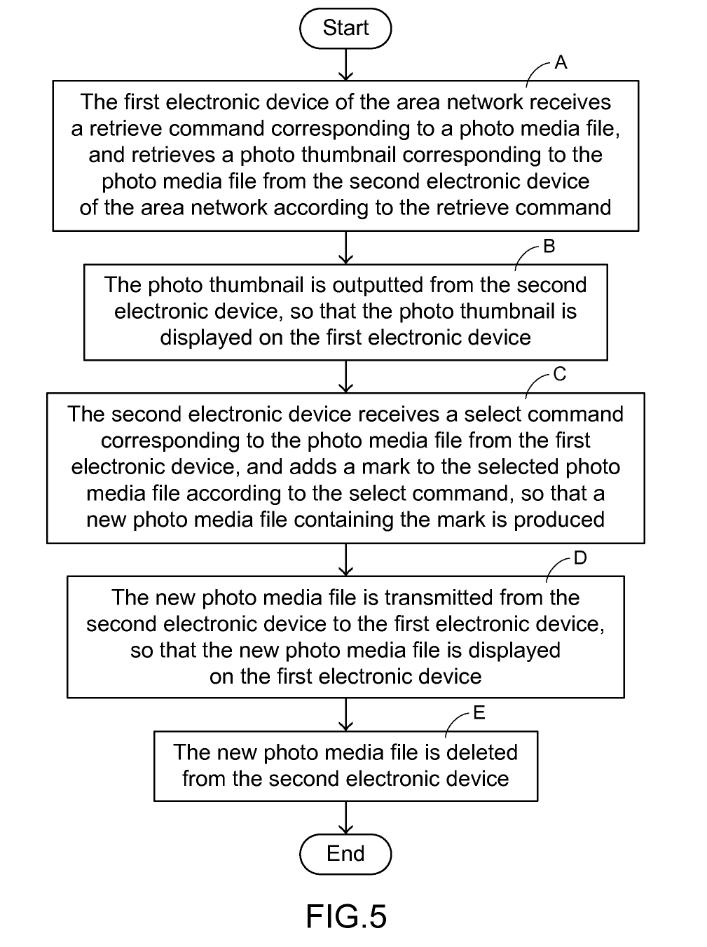

Hereinafter, a photo media displaying system of the present invention will be illustrated with reference to FIG. 4. FIG. 4 is a schematic functional block diagram illustrating a photo media displaying system according to a first embodiment of the present invention. As shown in FIG. 4, the photo media displaying system 4 comprises a network router 41, a first electronic device 42, and a second electronic device 43. The network router 41 is used to provide a network connection function. The first electronic device 42 and the second electronic device 43 are connected with each other via the network router 41 through network connection. The first electronic device 42 is connected to the network router 41 through network connection. Moreover, the first electronic device 42 is connected to the second electronic device 43 via the network router 41 through network connection. The first electronic device 42 comprises a display screen 421 and an operation interface 422. When the first electronic device 42 is connected to the second electronic device 43 through network connection, plural photo thumbnails T1˜Tn corresponding to plural photo media files P1˜Pn may be displayed on the display screen 421. The operation interface 422 is displayed on the display screen 421 or a surface of the first electronic device 42. The user may input a first select command S1, a second select command S2 and a print command S3 via the operation interface 422. In this embodiment, the display screen 421 and the operation interface 422 are integrated into a touch screen.

The second electronic device 43 is connected to the network router 41 through network connection. Moreover, the second electronic device 43 is connected to the first electronic device 42 via the network router 41 through network connection. The second electronic device 43 comprises a storage element 431 and a controlling unit 432. Moreover, a mark R, the plural photo media files P1˜Pn and the plural photo thumbnails T1˜Tn corresponding to the plural photo media files P1˜Pn are stored in the storage element 431. The controlling unit 432 is connected to the second storage element 431. In response to the user's operation, the mark R is added to a selected photo media file by the controlling unit 432, so that a new photo media file Pnew is produced and outputted. In this embodiment, the network router 41, the first electronic device 42 and the second electronic device 43 are collaboratively defined as an area network 40. Moreover, the network router 41 complies with the universal plug and play (UPnP) protocol, and both of the first electronic device 42 and the second electronic device 43 comply with the Digital Living Network Alliance (DLNA) protocol. In this embodiment, the first electronic device 42 is a digital media player (e.g. a smart phone), the second electronic device 43 is a digital media server, the second storage element 431 is a hard disc, and the controlling unit 432 is a microprocessor.

It is noted that the mark R is previously stored in the storage element 431. For previously storing the mark R, the user may allow a third-party device (e.g. a computer) to be connected to the second electronic device 43, and then transmit the mark R from the third-party device to the second electronic device 43 and store the mark R into the storage element 431. The process of previously storing the mark R is similar to the process of setting the second electronic device 43. The process of setting the second electronic device 43 (i.e. the digital media server) is well known to those skilled in the art, and is not redundantly described herein.

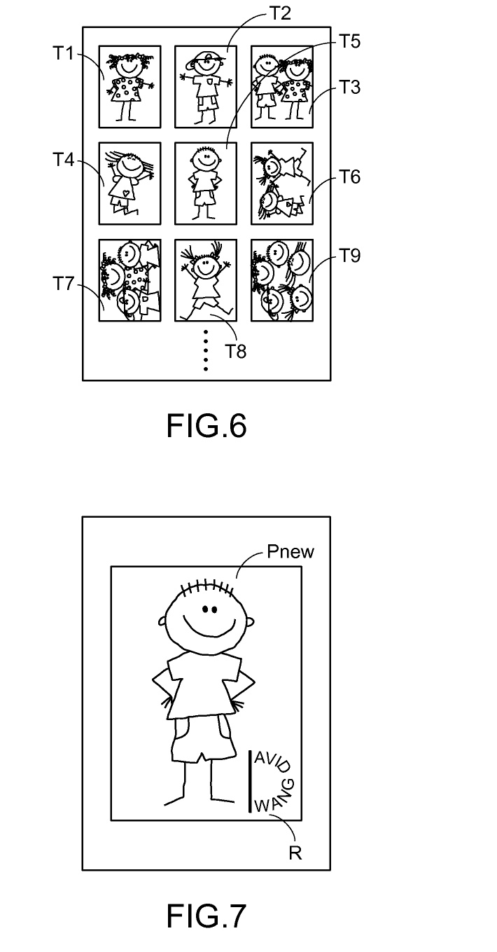

Hereinafter, a photo media displaying method according to the present invention will be illustrated with reference to FIG. 5. FIG. 5 is a flowchart illustrating a photo media displaying method according to a first embodiment of the present invention. The photo media displaying method comprises the following steps.

In a step A, the first electronic device of the area network receives a retrieve command corresponding to a photo media file, and retrieves a photo thumbnail corresponding to the photo media file from the second electronic device of the area network according to the retrieve command. In a step B, the photo thumbnail is outputted from the second electronic device, so that the photo thumbnail is displayed on the first electronic device. In a step C, the second electronic device receives a select command corresponding to the photo media file from the first electronic device, and add a mark to the selected photo media file according to the select command, so that a new photo media file containing the mark is produced. In a step D, the new photo media file is transmitted from the second electronic device to the first electronic device, so that the new photo media file is displayed on the first electronic device. In a step E, the new photo media file is deleted from the second electronic device.

The step C comprises the following sub-steps C1-C3. In the sub-step C1, the photo media file is selected according to the select command. In the sub-step C2, the mark is superposed on the selected photo media file, so that the new photo media file is produced. In the sub-step C3, the new photo media file is temporarily stored into the second electronic device.

The step D comprises the following sub-steps D1˜D3. In the sub-step D1, the new photo media file is transmitted from the second electronic device to the first electronic device. In the sub-step D2, the new photo media file is deleted the second electronic device according to a reception completion message from the first electronic device. In the sub-step D3, the new photo media file is displayed on the first electronic device.

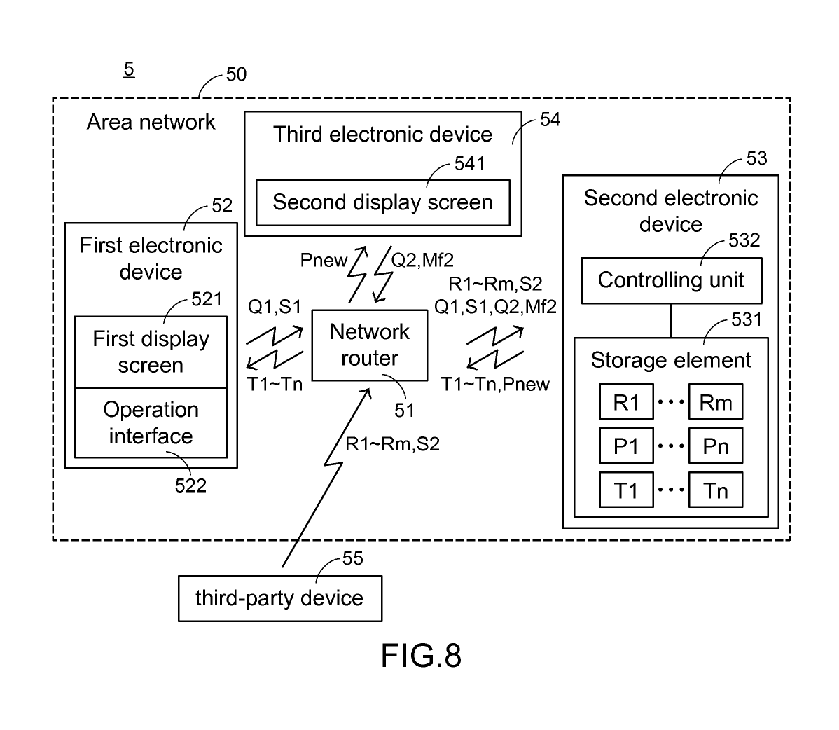

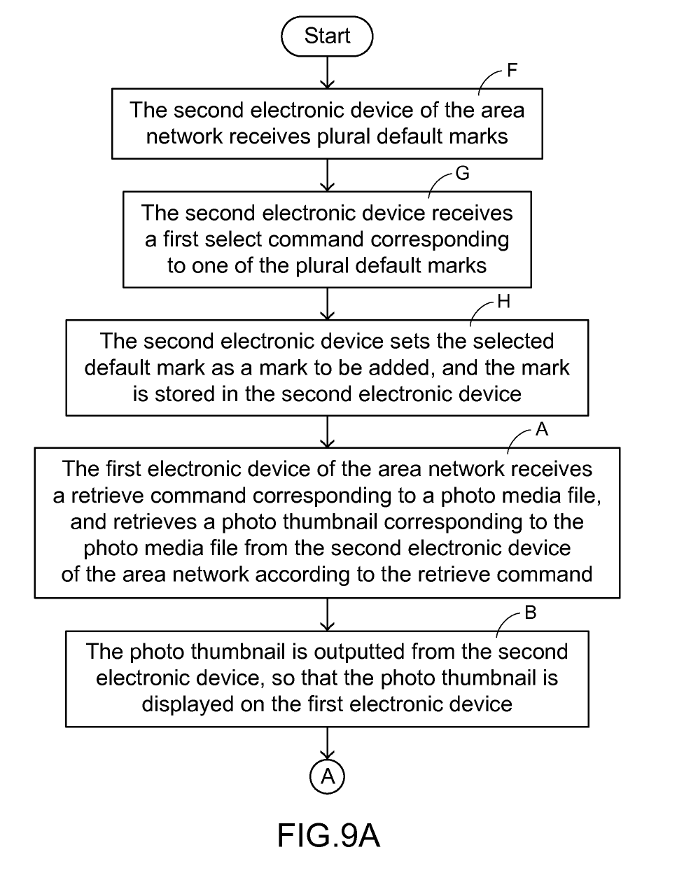

Hereinafter, the detailed procedures of the photo media displaying method implemented by the photo media displaying system 4 will be illustrated with reference to FIGS. 4˜7. FIG. 6 schematically illustrates plural thumbnails corresponding to plural photo media files of the photo media displaying system according to the first embodiment of the present invention. FIG. 7 schematically illustrates a new photo media file produced by the photo media displaying system according to the first embodiment of the present invention.

Firstly, in response to a user's operation via the operation interface 422 of the first electronic device 42, the first electronic device 42 is connected to the second electronic device 43 through network connection. Moreover, in response to the user's operation, a retrieve command is received by the first electronic device 42, and a retrieve request Q1 corresponding to plural photo thumbnails T1˜Tn is transmitted from the first electronic device 42 to the second electronic device 43 in order to retrieve the plural photo thumbnails T1˜Tn from the second electronic device 43. That is, the A is performed. According to the retrieve request Q1, the plural photo thumbnails T1˜Tn corresponding to plural photo media files P1˜Pn are transmitted from the second electronic device 43 to the first electronic device 42. When the plural photo thumbnails T1˜Tn are received by the first electronic device 42, the plural photo thumbnails T1˜Tn are displayed on the display screen 421. That is, the step B is performed. The examples of some of the plural photo thumbnails T1˜Tn are shown in FIG. 6.

Then, in the sub-step C1, the user may input a first select command S1 corresponding to the photo media file P5 via the operation interface 422. That is, by touching the display screen 421 to select the photo thumbnail T5, the first electronic device 42 may transmit the first select command S1 to the second electronic device 43. In particular, after the user touches the photo thumbnail T5 to generate the first select command S1, the photo media file P5 is selected. After the first select command S1 is received by the second electronic device 43, according to the first select command S1, the mark R which is previously stored in the storage element 431 is superposed on the selected photo media file P5 by the controlling unit 432, so that the new photo media file Pnew is produced. That is, the sub-step C2 is performed. After the new photo media file Pnew is produced, the new photo media file Pnew is temporarily stored into the storage element 431. That is, the sub-step C3 is performed. Moreover, the approach of superposing the mark R on the selected photo media file P5 to produce the new photo media file Pnew may be achieved by a watermark generation technology or a stamp mark generation technology. The principles of the watermark generation technology and the stamp mark generation technology are well known to those skilled in the art, and are not redundantly described herein.

After the new photo media file Pnew is produced, in response to the user's operation, a retrieve request Q2 corresponding to the new photo media file Pnew is transmitted from the first electronic device 42 to the second electronic device 43 in order to retrieve the new photo media file Pnew from the second electronic device 43. According to the retrieve request Q2, the new photo media file Pnew is transmitted from the second electronic device 43 to the first electronic device 42, and the new photo media file Pnew is displayed on the display screen 421. An example of the new photo media file Pnew is shown in FIG. 7. That is, the step D is performed.

After the new photo media file Pnew is received by the first electronic device 42, a reception completion message Mf1 is transmitted from the first electronic device 42 to the second electronic device 43. According to the reception completion message Mf1, the controlling unit 432 realizes that the new photo media file Pnew is completely received by the first electronic device 42. Under this circumstance, the new photo media file Pnew is deleted from the storage element 431 by the controlling unit 432. That is, the step E is performed. Meanwhile, the photo media displaying method is completed. After the new photo media file Pnew is deleted from the second storage element 431, the storage space of the storage element 431 is not occupied by the new photo media file Pnew, and thus the original storing status of the storage element 431 is maintained.

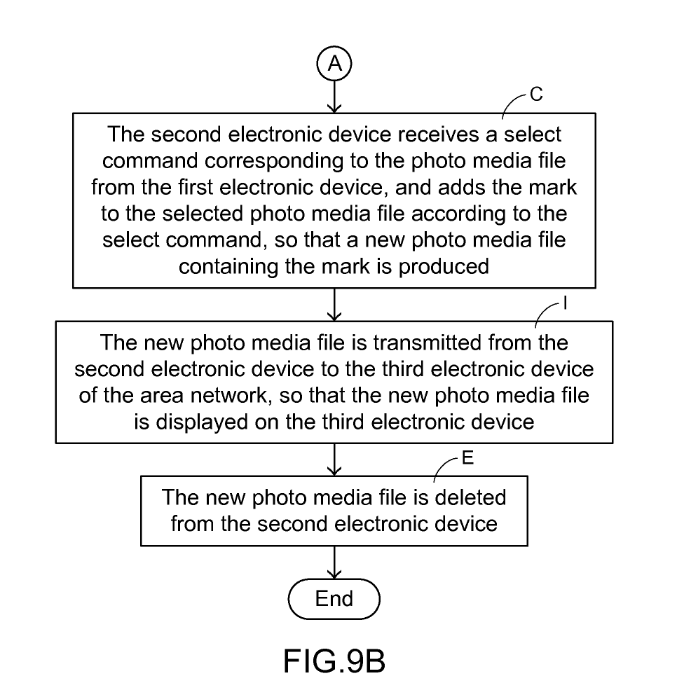

The present invention further provides a second embodiment, which is distinguished from the first embodiment. FIG. 8 is a schematic functional block diagram illustrating a photo media displaying system according to a second embodiment of the present invention. As shown in FIG. 8, the photo media displaying system 5 comprises a network router 51, a first electronic device 52, a second electronic device 53, and a third electronic device 54. In this embodiment, the network router 51, the first electronic device 52, the second electronic device 53 and the third electronic device 54 are collaboratively defined as an area network 50. The first electronic device 52 comprises a first display screen 521 and an operation interface 522. The second electronic device 53 comprises a storage element 531 and a controlling unit 532. The third electronic device 54 comprises a second display screen 541. In this embodiment, the first electronic device 52 is an active control device (e.g. a digital media controller), the second electronic device 53 is a digital media server, and the third electronic device 54 is a digital media renderer.

The configurations and operations of the network router 51, the first electronic device 52 and the second electronic device 53 are identical to those of the photo media displaying system of the first embodiment, and are not redundantly described herein. In comparison with the first embodiment, the photo media displaying system 5 further comprises the third electronic device 54 in the area network 50. The operations of the third electronic device 54 will be illustrated in more details as follows.

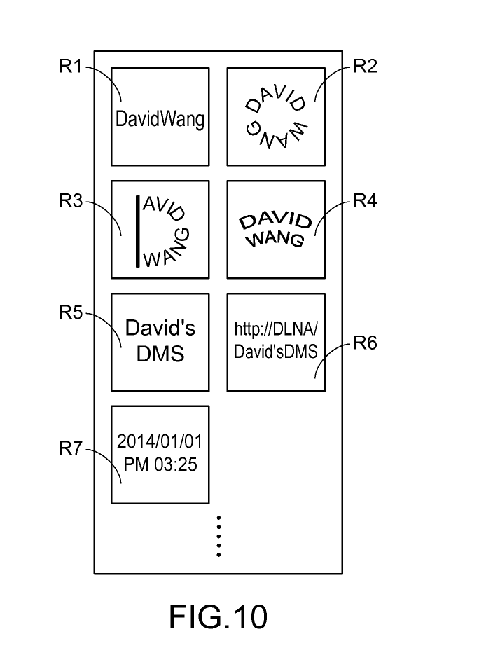

FIG. 9A and FIG. 9B are flowcharts illustrating a photo media displaying method according to a second embodiment of the present invention. The photo media displaying method comprises the following steps.

In a step F, the second electronic device of the area network receives plural default marks. In a step G, the second electronic device receives a first select command corresponding to one of the plural default marks. In a step H, the second electronic device sets the selected default mark as a mark to be added, and the mark is stored in the second electronic device. In a step A, the first electronic device of the area network receives a retrieve command corresponding to a photo media file, and retrieves a photo thumbnail corresponding to the photo media file from the second electronic device of the area network according to the retrieve command. In a step B, the photo thumbnail is outputted from the second electronic device, so that the photo thumbnail is displayed on the first electronic device. In a step C, the second electronic device receives a second select command corresponding to the photo media file from the first electronic device, and adds the mark to the selected photo media file according to the second select command, so that a new photo media file containing the mark is produced. In a step D, the new photo media file is transmitted from the second electronic device to the third electronic device of the area network, so that the new photo media file is displayed on the third electronic device. In a step E, the new photo media file is deleted from the second electronic device.

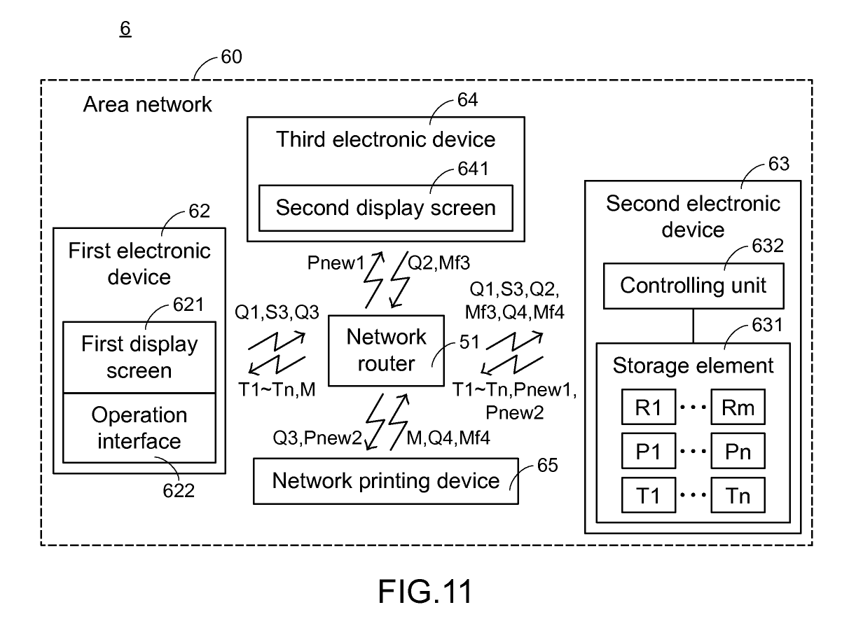

In comparison with the first embodiment, the photo media displaying method of this embodiment further comprises the steps F˜H, and the step D of the first embodiment is replaced by the step I. The steps F˜H are related to a mark creating process. The operations of the photo media displaying method of this embodiment will be illustrated as follows. Firstly, the user may allow a third-party device 55 to be connected to the second electronic device 53, and then transmit plural default marks R1˜Rm from the third-party device 55 to the second electronic device 53. That is, the step F is performed. The examples of some of the plural default marks R1˜Rm are shown in FIG. 10. As shown in FIG. 10, the default mark R1 denotes a name information of the user, the default marks R2˜R4 denotes the name images of the user, the default mark R5 denotes a name information of the second electronic device 53, the default mark R6 denotes and address information of the second electronic device 53, and the default mark R7 denotes a time information of creating the mark. Then, the user may operate the third-party device 55 to issue a second select command S2 in order to select the default mark R2 as the mark R. In addition, the mark R is received by the second electronic device 53 in the step G. In the step H, according to the user's selection, the selected default mark R2 is set as the mark R, and the mark R is stored in the storage element 531 of the second electronic device 53. Meanwhile, the mark creating process is completed.

After the mark creating process is completed, the steps A-C as described in the first embodiment are performed by the photo media displaying system 5 of this embodiment. Consequently, the new photo media file Pnew is produced. After the new photo media file Pnew is produced, in response to the user's operation, a retrieve request Q2 corresponding to the new photo media file Pnew is transmitted from the third electronic device 54 to the second electronic device 53 in order to retrieve the new photo media file Pnew from the second electronic device 53. According to the retrieve request Q2, the new photo media file Pnew is transmitted from the second electronic device 53 to the third electronic device 54, and the new photo media file Pnew is displayed on the second display screen 541 of the third electronic device 54. That is, the step I is performed. After the new photo media file Pnew is received by the third electronic device 54, a reception completion message Mf2 is transmitted from the third electronic device 54 to the second electronic device 53. According to the reception completion message Mf2, the controlling unit 532 realizes that the new photo media file Pnew is completely received by the third electronic device 54. Under this circumstance, the new photo media file Pnew is deleted from the storage element 531 by the controlling unit 532. That is, the step E is performed. Meanwhile, the photo media displaying method is completed.

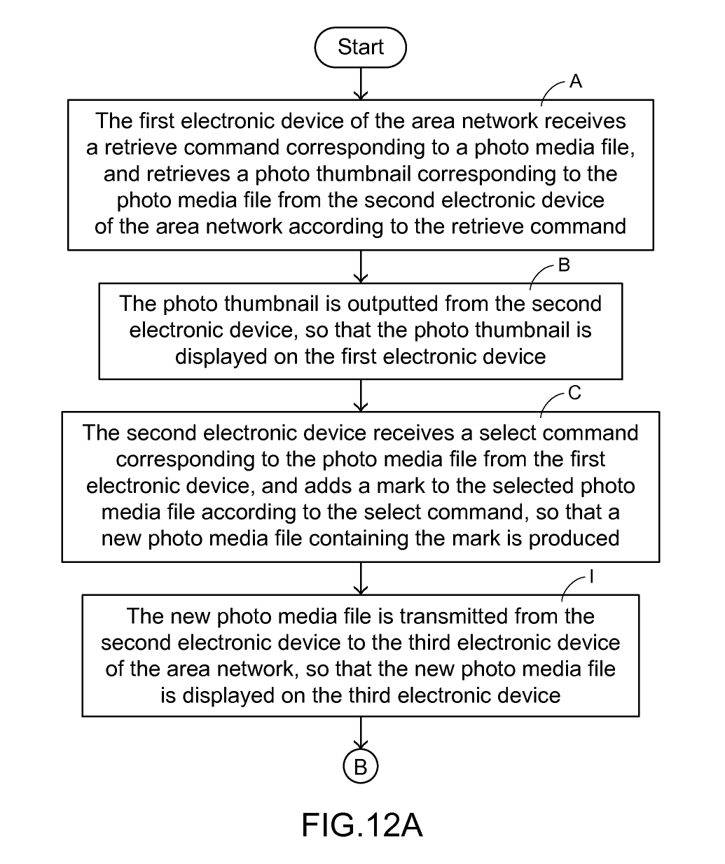

The present invention further provides a third embodiment, which is distinguished from the above embodiments. FIG. 11 is a schematic functional block diagram illustrating a photo media displaying and printing system according to a third embodiment of the present invention. As shown in FIG. 11, the photo media displaying and printing system 6 comprises a network router 61, a first electronic device 62, a second electronic device 63, a third electronic device 64, and a network printing device 65. In this embodiment, the network router 61, the first electronic device 62, the second electronic device 63, the third electronic device 64 and the network printing device 65 are collaboratively defined as an area network 60. The first electronic device 62 comprises a first display screen 621 and an operation interface 622. The second electronic device 63 comprises a storage element 631 and a controlling unit 632. The third electronic device 64 comprises a second display screen 641. The network printing device 65 is connected to the network router 61 through network connection. Moreover, the network printing device 65 is connected to the first electronic device 62 and the second electronic device 63 via the network router 61 through network connection. The network printing device 65 may receive a print-ready photo media file and print out the print-ready photo media file. In this embodiment, the first electronic device 62 is an active control device (e.g. a digital media controller), the second electronic device 63 is a digital media server, and the third electronic device 64 is a digital media renderer. The configurations of the network router 61, the first electronic device 62, the second electronic device 63 and the third electronic device 64 of this embodiment are identical to those of the photo media displaying system of the second embodiment, and are not redundantly described herein.

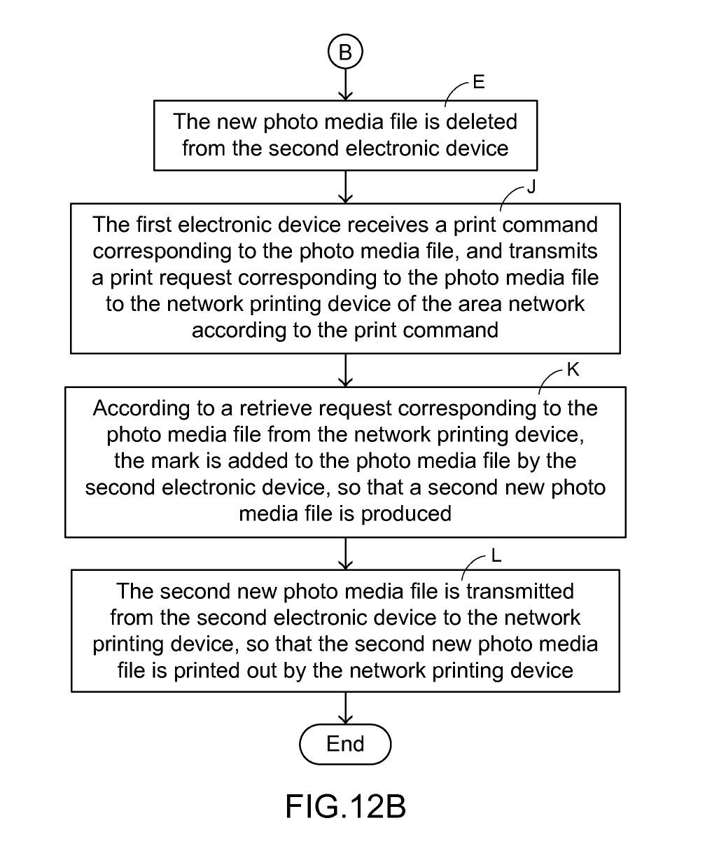

Hereinafter, a photo media displaying and printing method according to the present invention will be illustrated with reference to FIG. 12A and FIG. 12B. FIG. 1212A and FIG. 12B are flowcharts illustrating a photo media displaying and printing method according to a third embodiment of the present invention. The photo media displaying and plating method comprises the following steps.

In a step A, the first electronic device of the area network receives a retrieve command corresponding to a photo media file, and retrieves a photo thumbnail corresponding to the photo media file from the second electronic device of the area network according to the retrieve command. In a step B, the photo thumbnail is outputted from the second electronic device, so that the photo thumbnail is displayed on the first electronic device. In a step C, the second electronic device receives a select command corresponding to the photo media file from the first electronic device, and adds the mark to the selected photo media file according to the select command, so that a first new photo media file containing the mark is produced. In a step I, the first new photo media file is transmitted from the second electronic device to the third electronic device of the area network, so that the first new photo media file is displayed on the third electronic device. In a step E, the first new photo media file is deleted from the second electronic device. In a step J, the first electronic device receives a print command corresponding to the photo media file, and transmits a print request corresponding to the photo media file to the network printing device of the area network according to the print command. In a step K, according to a retrieve request corresponding to the photo media file from the network printing device, the mark is added to the photo media file by the second electronic device, so that a second new photo media file is produced. In a step L, the second new photo media file is transmitted from the second electronic device to the network printing device, so that the second new photo media file is printed out by the network printing device.

The step C comprises the following sub-steps C1˜C3. In the sub-step C1, the photo media file is selected according to the select command. In the sub-step C2, the mark is superposed on the selected photo media file, so that the first new photo media file is produced. In the sub-step C3, the first new photo media file is temporarily stored into the second electronic device.

The step K comprises the following sub-steps K1˜K4. In the sub-step K1, the retrieve request corresponding to the photo media file is transmitted from the network printing device to the second electronic device according to the print request. In the sub-step K2, the photo media file is selected by the second electronic device according to the retrieve request. In the sub-step K3, the mark is superposed on the selected photo media file, so that the second new photo media file is produced. In the sub-step K4, the second new photo media file is temporarily stored into the second electronic device.

The step L comprises the following sub-steps L1˜L3. In the sub-step L1, the second new photo media file is transmitted from the second electronic device to the network printing device according to the retrieve request corresponding to the second new photo media file. In the sub-step L2, the second new photo media file is printed out by the network printing device. In the sub-step L3, the second new photo media file is deleted from the second electronic device.

The detailed procedures of the photo media displaying and printing method implemented by the photo media displaying and printing system 6 will be illustrated as follows.

Firstly, in response to a user's operation via the operation interface 622 of the first electronic device 62, the first electronic device 62 is connected to the second electronic device 63 through network connection.

Moreover, in response to the user's operation, a retrieve command is received by the first electronic device 62, and a retrieve request Q1 corresponding to plural photo thumbnails T1˜Tn is transmitted from the first electronic device 62 to the second electronic device 63 in order to retrieve the plural photo thumbnails T1˜Tn from the second electronic device 63. That is, the step A is performed. According to the retrieve request Q1, the plural photo thumbnails T1˜Tn corresponding to plural photo media files P1˜Pn are transmitted from the second electronic device 63 to the first electronic device 62. When the plural photo thumbnails T1˜Tn are received by the first electronic device 62, the plural photo thumbnails T1˜Tn are displayed on the display screen 621. That is, the step B is performed.

Then, the user may input a select command S3 corresponding to the photo media file P8 via the operation interface 622. That is, by touching the first display screen 621 to select the photo thumbnail T8, the select command S3 is transmitted from the first electronic device 62 to the second electronic device 63. That is, the sub-step C1 is performed. In particular, after the user touches the photo thumbnail T8 on the first display screen 621 to generate the select command S3, the photo media file P8 is selected. After the select command S3 is received by the second electronic device 63, according to the select command S3, the mark R which is previously stored in the storage element 631 is superposed on the selected photo media file P8 by the controlling unit 632, so that a first new photo media file Pnew1 is produced. That is, the sub-step C2 is performed. After the first new photo media file Pnew1 is produced, the first new photo media file Pnew1 is temporarily stored into the storage element 631. That is, the sub-step C3 is performed.

After the first new photo media file Pnew1 is produced, in response to the user's operation, a retrieve request Q2 corresponding to the first new photo media file Pnew1 is transmitted from the third electronic device 64 to the second electronic device 63 in order to retrieve the first new photo media file Pnew1 from the second electronic device 63. According to the retrieve request Q2, the first new photo media file Pnew1 is transmitted from the second electronic device 63 to the third electronic device 64, and the first new photo media file Pnew1 is displayed on the second display screen 641 of the third electronic device 64. That is, the step I is performed. After the first new photo media file Pnew1 is received by the third electronic device 64, a reception completion message Mf3 is transmitted from the third electronic device 64 to the second electronic device 63. According to the reception completion message Mf3, the controlling unit 632 realizes that the first new photo media file Pnew1 is completely received by the third electronic device 64. Under this circumstance, the first new photo media file Pnew1 is deleted from the storage element 631 by the controlling unit 632. That is, the step E is performed. Meanwhile, the photo media displaying process of the photo media displaying and printing method is completed.

The photo media printing process of the photo media displaying and printing method of the present invention will be illustrated as follows. In the step I, the user may browse the first new photo media file Pnew1 through the second display screen 641 in order to judge whether the first new photo media file Pnew1 is intended to be printed out or not. If the user decides to print out the new photo media file Pnew1, the user may operate the operation interface 622 of the first electronic device 62 to have the operation interface 622 receive a print command corresponding to the photo media file P8. According to the print command, a print request Q3 corresponding to the photo media file P8 is transmitted from the first electronic device 62 to the network printing device 65. That is, the step J is performed.

Moreover, after the print request Q3 is received by the network printing device 65, the response message M corresponding to the print request Q3 is transmitted from the network printing device 65 to the first electronic device 62, and the contents of the print request Q3 are analyzed by the network printing device 65. After the contents of the print request Q3 are completely analyzed by the network printing device 65, according to the analyzing result of the print request Q3, the network printing device 65 may realize that the print-ready photo media file is the photo media file P8. Consequently, a retrieve request Q4 corresponding to the photo media file P8 is transmitted from the network printing device 65 to the second electronic device 63. That is, the sub-step K1 is performed. According to the retrieve request Q4, the photo media file P8 is selected by the controlling unit 632 of the second electronic device 63. That is, the sub-step K2 is performed. Then, the mark R is superposed on the selected photo media file P8 by the controlling unit 632, so that a second new photo media file Pnew2 is produced. That is, the sub-step K3 is performed. Then, the second new photo media file Pnew2 is temporarily stored into the storage element 631. That is, the sub-step K4 is performed. The contents of the first new photo media file Pnew1 and the contents of the second new photo media file Pnew2 are identical. That is, for the user, the first new photo media file Pnew1 and the second new photo media file Pnew2 are identical. In fact, the ways of generating the first new photo media file Pnew1 and the second new photo media file Pnew2 are different.

Then, according to the retrieve request Q4, the second new photo media file Pnew2 is transmitted from the controlling unit 632 to the network printing device 65. That is, the sub-step L1 is performed. After the second new photo media file Pnew2 is received, the second new photo media file Pnew2 is printed out by the network printing device 65 according to the analyzing result of the print request Q3. That is, the sub-step L2 is performed. After the second new photo media file Pnew2 is completely printed out, a print completion message Mf4 is transmitted from the network printing device 65 to the second electronic device 63. According to the print completion message Mf4, the controlling unit 632 realizes that the second new photo media file Pnew2 is completely printed out. Under this circumstance, the second new photo media file Pnew2 is deleted from the second storage element 631 by the controlling unit 632. That is, the sub-step L3 is performed. Meanwhile, the photo media printing process of the photo media displaying and printing method is completed.

The following four aspects should be specially described. Firstly, after the new photo media file Pnew is deleted from the storage element 631, the storage space of the storage element 631 is not occupied by the new photo media file Pnew, and thus the original storing status of the storage element 631 is maintained. Secondly, in this embodiment, the default mark R is directly used. It is noted that the approach of setting the mark is not restricted. For example, before the step A, the mark creating process as described in the second embodiment may be performed in order to select the desired mark. Thirdly, in the step I of this embodiment, the first new photo media file Pnew1 is displayed on the second display screen 641 of the third electronic device 64. It is noted that the first new photo media file Pnew1 may be also displayed on the first display screen 621 of the first electronic device 62. Fourthly, in the step B of this embodiment, the following operations may be performed according to special settings.

For example, the mark R may be added to the plural photo thumbnails T1˜Tn by the second electronic device 63, so that plural new photo thumbnails containing the mark R are produced. Consequently, the efficacy of preventing the photo thumbnails from being embezzled by other users will be enhanced.

From the above descriptions, the present invention provides a photo media displaying and printing system, a photo media displaying method and a photo media printing method. After a task of adding a mark is performed by a digital media server, a new photo media file with the added mark is produced. Then, according to the practical requirements, the new photo media file may be transmitted to a digital media controller or a digital media renderer to be displayed, or the new photo media file may be transmitted to a network printing device to be printed out. As previously described in the prior art, the mark is manually added to the photo media file, and the new photo media file containing the mark is transmitted to the photo media printing system after the mark is mark is added to the photo media file. That is, the conventional technology is inconvenient and troublesome. According to the present invention, the photo media file containing the mark may be printed out by simply selecting the ready-print photo media file. In comparison with the conventional technology, the photo media displaying method and the photo media printing method of the present invention are simplified without the need of performing complicated operations. Moreover, the photo media displaying method and the photo media printing method of the present invention may additionally produce the new photo media file containing the mark without the need of changing the original photo media file. Consequently, the original storing status of the digital media server is maintained.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A photo media printing method, comprising steps of:
(A) allowing a first electronic device of an area network to receive a print command corresponding to a photo media file, so that a print request corresponding to the photo media file is transmitted from the first electronic device to a network printing device of the area network, wherein the photo media file is stored in a second electronic device of the area network;
(B) the second electronic device adding a mark to the photo media file according to a retrieve request corresponding to the photo media file from the network printing device, so that a new photo media file containing the mark is produced; and
(C) transmitting the new photo media file from the second electronic device to the network printing device, so that the new photo media file is printed out by the network printing device.

2. The photo media printing method according to claim 1, wherein before the step (A), the photo media printing method further comprises steps of:
(X1) allowing the first electronic device to receive a retrieve command corresponding to the photo media file, so that a photo thumbnail corresponding to the photo media file is retrieved from the second electronic device, wherein the photo thumbnail is stored in the second electronic device;
(X2) outputting the photo thumbnail from the second electronic device, so that the photo thumbnail is displayed on the first electronic device;
(X3) allowing the second electronic device to receive a select command corresponding to the photo media file from the first electronic device, so that the mark is added to the selected photo media file according to the select command and an additional new photo media file containing the mark is produced; and
(X4) transmitting the additional new photo media file from the second electronic device to the first electronic device or a third electronic device of the area network, so that the additional new photo media file is displayed on the first electronic device or the third electronic device, wherein the third electronic device is a digital media renderer according to a DLNA protocol.

3. The photo media printing method according to claim 1, wherein before the step (B), the photo media printing method further comprises a mark creating process, and the mark creating process comprises steps of:
(P1) the second electronic device receiving plural default marks;
(P2) allowing the second electronic device to receive another select command corresponding to a selected default mark of the plural default marks; and
(P3) the second electronic device setting the selected default mark as the mark and storing the mark therein, wherein each of the plural default marks contains a name information of a user, a name image of the user, a name information of the second electronic device, an address information of the second electronic device or a time information of creating the mark.

4. The photo media printing method according to claim 1, wherein the step (B) comprises sub-steps of:
(B1) transmitting the retrieve request corresponding to the photo media file from the network printing device to the second electronic device according to the print command;
(B2) the second electronic device selecting the photo media file according to the retrieve request corresponding to the photo media file;
(B3) superposing the mark on the selected photo media file, so that the new photo media file is produced; and
(B4) temporarily storing the new photo media file into the second electronic device.

5. The photo media printing method according to claim 1, wherein the step (C) comprises sub-steps of:
(C1) transmitting the new photo media file from the second electronic device to the network printing device according to a retrieve request corresponding to the new photo media file;
(C2) printing out the new photo media file by the network printing device; and
(C3) deleting the new photo media file from the second electronic device after the new photo media file is printed out.

6. The photo media printing method according to claim 1, wherein the first electronic device is a digital media controller or a digital media player according to a DLNA protocol, the second electronic device is a digital media server according to the DLNA protocol, and the network printing device is a digital media printer according to the DLNA protocol.

7. A photo media displaying method, comprising steps of:
(A) allowing a first electronic device of an area network to receive a retrieve command corresponding to a photo media file, so that a photo thumbnail corresponding to the photo media file is retrieved from a second electronic device of the area network, wherein the photo media file and the photo thumbnail are stored in the second electronic device;
(B) outputting the photo thumbnail from the second electronic device, so that the photo thumbnail is displayed on the first electronic device;
(C) allowing the second electronic device to receive a select command corresponding to the photo media file from the first electronic device, so that the mark is added to the selected photo media file according to the select command and a new photo media file containing the mark is produced; and
(D) transmitting the new photo media file from the second electronic device to the first electronic device or a third electronic device of the area network, so that the new photo media file is displayed on the first electronic device or the third electronic device.

8. The photo media displaying method according to claim 7, wherein before the step (C), the photo media displaying method further comprises a mark creating process, and the mark creating process comprises steps of:
(P1) the second electronic device receiving plural default marks;
(P2) allowing the second electronic device to receive another select command corresponding to a selected default mark of the plural default marks; and
(P3) the second electronic device setting the selected default mark as the mark and storing the mark therein, wherein each of the plural default marks contains a name information of a user, a name image of the user, a name information of the second electronic device, an address information of the second electronic device or a time information of creating the mark.

9. The photo media displaying method according to claim 7, wherein the step (C) comprises sub-steps of:
(C1) selecting the photo media file according to the select command;
(C2) superposing the mark on the selected photo media file, so that the new photo media file is produced; and
(C3) temporarily storing the new photo media file into the second electronic device.

10. The photo media displaying method according to claim 7, wherein the step (D) comprises sub-steps of:
(D1) transmitting the new photo media file from the second electronic device to the first electronic device or the third electronic device;
(D2) deleting the new photo media file from the second electronic device according to a reception completion message from the first electronic device or the third electronic device; and
(D3) displaying the new photo media file on the first electronic device or the third electronic device after the new photo media file is received.

11. The photo media displaying method according to claim 7, wherein the first electronic device is a digital media controller or a digital media player according to a DLNA protocol, the second electronic device is a digital media server according to the DLNA protocol, the third electronic device is a digital media renderer according to the DLNA protocol, and the network printing device is a digital media printer according to the DLNA protocol.

12. A photo media displaying and printing system, comprising:
a network router providing a network connection function;
an active control device connected to the network router through network connection, wherein the active control device comprises a first display screen and an operation interface, wherein a photo media file and a new photo media file containing a mark are displayed on the first display screen, and the operation interface receives a select command corresponding to the photo media file and a print command corresponding to the photo media file, wherein the active control device issues a print request according to the print command;
a digital media printer connected to the network router through network connection and connected to the active control device via the network router through network connection, wherein the digital media printer issues a retrieve request corresponding to the photo media file, wherein after the new photo media file is received, the new photo media file is printed out by the digital media printer; and
a digital media server connected to the network router through network connection, and connected to the active control device and the digital media printer via the network router through network connection, wherein the digital media server comprises a storage element and a controlling element, wherein the mark and the photo media file are stored in the storage element, and the controlling unit is connected to the storage element, wherein the controlling unit adds the mark to the selected photo media file according to the retrieve request so as to produce and output the new photo media file, or the controlling unit adds the mark to the selected photo media file according to the print request so as to produce and output the new photo media file to the digital media printer.

13. The photo media displaying and printing system according to claim 12, further a digital media renderer, wherein the digital media renderer is connected to the network router through network connection and connected to the active control device and the digital media server via the network router through network connection, wherein the digital media renderer comprises a second display screen, and the new photo media file is displayed on the second display screen after the new photo media file is received by the digital media renderer, wherein the active control device, the digital media server and the digital media renderer comply with a DLNA protocol, and the network router complies with a UPnP protocol.

14. The photo media displaying and printing system according to claim 13, wherein after the new photo media file is received by the active control device or the digital media renderer, a reception completion message is transmitted from the active control device or the digital media renderer to the digital media server, wherein the new photo media file is deleted from the storage element by the controlling unit according to the reception completion message.

15. The photo media displaying and printing system according to claim 12, wherein plural default marks are stored in the storage element, wherein when the plural default marks are displayed and another select command corresponding to a selected default mark of the plural default marks is received by the controlling unit, the selected default mark is set as the mark to be added to the photo media file by the controlling unit, wherein each of the plural default marks contains a name information of a user, a name image of the user, a name information of the digital media server, an address information of the digital media server or a time information of creating the mark.

16. The photo media displaying and printing system according to claim 12, wherein after the print request is received by the digital media printer, a response message is transmitted from the digital media printer to the active control device, the print request is analyzed by the digital media printer, and the retrieve request corresponding to the photo media file is transmitted from the digital media printer to the digital media server according to an analyzing result of the print request.

17. The photo media displaying and printing system according to claim 16, wherein after the retrieve request is received by the digital media server, the new photo media file is transmitted from the digital media server to the digital media printer, so that the new photo media file is printed out by the digital media printer, wherein after the new photo media file is completely printed out by the digital media printer, a print completion message is outputted from the network printing device, wherein the new photo media file is deleted from the storage element by the controlling unit according to the print completion message.
